(19) United States
(12) Patent Application Publication
(10) Pub. No.: US 2026/0166527 A1
(43) Pub. Date: Jun. 18, 2026

(54) MIXED METAL OXIDE CATALYSTS AND COMPOSITIONS AND PROCESSES FOR THE PRODUCTION THEREOF

(71) Applicant: AETHER CATALYST SOLUTIONS, INC., Burnaby (CA)

(72) Inventors: Taylor PROCYK, Burnaby (CA); Greg JAMES, Burnaby (CA); Vahid MORADI, Burnaby (CA)

(21) Appl. No.: 19/127,047

(22) PCT Filed: Nov. 3, 2023
(86) PCT No.: PCT/CA2023/051469

§ 371 Date: May 2, 2025

Related U.S. Application Data
(60) Provisional application No. 63/422,747, filed on Nov. 4, 2022.

(51) Int. Cl. B01J 23/83; B01D 53/86; B01J 23/00; B01J 23/10; B01J 23/75; B01J 37/02; B01J 37/08

(52) U.S. Cl. CPC B01J 23/83; B01D 53/8628; B01J 23/005; B01J 23/10; B01J 23/75; B01J 37/0215; B01J 37/088; B01D 2255/2065; B01D 2255/20746; B01D 2255/20761; B01D 2255/2092; B01D 2255/405

(57) ABSTRACT

Compositions of mixed metal oxides and mixed metal oxide catalysts are provided. The mixed metal oxide compositions and mixed metal oxide catalysts comprise aluminum, cobalt and copper, wherein at least a portion of the composition comprises a ternary spinel structure. Processes for the preparation of mixed metal oxide catalysts, and methods of reducing pollutants with a mixed metal oxide composition or mixed metal oxide catalyst described herein are also provided.

### FIELD OF INVENTION

The present invention relates to mixed metal oxide catalysts and compositions.

More specifically, the present invention relates to mixed metal oxide catalysts and compositions comprising aluminum, cobalt and copper, uses thereof, and processes for preparation thereof.

### BACKGROUND

Catalysts, which increase the speed of chemical reactions, may be provided in the form of catalytic converters. Three-way catalytic converters, the primary emission control technology used in internal combustion engines, can oxidize carbon monoxide (CO) and hydrocarbons (HC) to produce carbon dioxide (CO₂) and water, and reduce nitrogen oxides (NO_{X}) to produce nitrogen. Decreasing the quantity of CO, HC, and NO_{X} has a positive impact on the environment by reducing the level of these harmful chemicals produced by internal combustion engines. Given the stricter emission regulations and guidelines implemented in various countries and jurisdictions, there is a need for better performing catalytic converters for internal combustion engines.

To ensure proper function of three-way catalytic converters, a balance between oxidization and reduction reactions is needed to ensure optimal conversion of pollutants. The ability to undergo oxidation and reduction reactions may be influenced by the presence of air, as it contains gases such as oxygen. In an ideal internal combustion engine system, the exact amount of air would be provided to completely burn all the fuel in the internal combustion engine, which is referred to as the stoichiometric mixture, or as operating at stoichiometric conditions. In practice, this is not currently attainable, and therefore, three-way catalytic converters may substantially operate under non-ideal conditions or use an oxygen monitoring and control system to operate at non-stoichiometric conditions. The control system, in combination with the oxygen monitor, allows the fuel to oscillate between lean and rich fuel conditions, wherein an excess of air in the combustion chamber may characterize lean conditions during combustion, and an excess of fuel in the combustion chamber may characterize rich conditions during combustion. Under stoichiometric conditions, the engine is operating with a lambda value of 1, with values greater than 1 representing lean conditions, and less than 1 representing fuel rich conditions.

Rich-burn combustion may only require a single three-way catalyst, thereby reducing engine temperatures and increasing engine power; however, rich-burn combustion may increase overall fuel consumption, which in turn may increase the amount of pollutants produced during combustion. Additionally, in rich-burn conditions, oxidation reactions, such as those that reduce NO_{X}, may be significantly impaired, thus requiring additional features. Lean conditions may increase fuel efficiency; however, these conditions increase engine temperature.

Traditional catalysts may use metals, such as, for example, platinum group metals, including platinum, rhodium, and palladium, for catalyzing oxidation and reduction reactions. These catalysts may be formed as compositions or catalyst precursors for application to carrier materials, substrates or other materials that may be conducive to the formation of the catalyst or catalytic converter. The combination of metals, as well as their quantity and ratio in a catalyst significantly changes their ability to function as catalysts or catalytic converters, owing to their unique thermostability and ability to undergo oxidation and reduction reactions at the required and/or desired reaction initialization temperature, operating temperature, or oxygen content.

Traditional three way catalytic converters, such as, for example, those described in U.S. Pat. No. 11,207,662B2 use expensive and rare metals, such as, for example, platinum group metals to reduce emissions. In addition to the high costs to produce such catalysts containing rare or costly metals, the conversion of emissions to less harmful species may be limited.

WO2019204127A1 teaches mixed metal oxide compositions comprising a ratio of elemental aluminum to cobalt to copper that lowers the reaction initialization temperature. WO2019204127A1 further teaches that an elemental ratio of Al:Co:Cu of 3:2:1 is preferred, as lower Al content decreases utility of the discloses catalysts, whereas increasing Al content has no effect on utility.

Existing mixed metal oxide compositions and catalysts are limited in their capacity to reduce NO_{X} at lambda values close to stoichiometry. Thus, there remains a need for catalytic converters and catalysts that reduce NO_{X} more efficiently at near stoichiometry.

### SUMMARY OF THE INVENTION

The present disclosure provides mixed metal oxide catalyst precursors or compositions and mixed metal oxide catalysts, which comprise aluminum, cobalt and copper, as well as processes for preparation thereof. The mixed metal oxide catalysts may offer one or more of the following improved features when compared with traditional compositions and catalysts, including, but not limited to: increased stability, increased longevity, increased emission reduction, increased NO_{X} reduction, increased CO reduction, increased hydrocarbon reduction, improved operating temperature, increased oxidation potential, increased reduction potential, lower reaction initialization temperature, improved lean fuel emission reduction, improved rich fuel emission reduction, ease of production, lower quantity of the composition of catalyst used, improved utility across a range of lambda values, and lower cost of production.

In one aspect of the disclosure, there is provided herein a mixed metal oxide catalyst comprising aluminum, cobalt and copper, wherein the elemental ratio of aluminum to cobalt to copper may be X:Y:1, wherein X is in the range of about 1 to about 80, and Y is in the range of about 1 to about 39, and wherein at least a portion of the catalyst comprises a ternary spinel structure. The catalyst may also comprise an amount of aluminum greater than or equal to the amount of cobalt.

In various embodiments, X may be in the range of about 5 to about 20, and Y may be in the range of about 2 to about 19. In various embodiments, X may be in the range of about 5 to about 20, and Y may be in the range of about 2 to about 19, and the catalyst comprises an amount of aluminum greater than or equal to the amount of cobalt.

In various embodiments, X may be in the range of about 7 to about 20, and Y may be in the range of about 3 to about 15. In various embodiments, X may be in the range of about 7 to about 20, and Y may be in the range of about 3 to about 15, and the catalyst comprises an amount of aluminum greater than or equal to the amount of cobalt.

In various embodiments, X may be in the range of about 7 to about 18, and Y may be in the range of about 3 to about 13. In various embodiments, X may be in the range of about 7 to about 18, and Y may be in the range of about 3 to about 13, and the catalyst comprises an amount of aluminum greater than or equal to the amount of cobalt.

In various embodiments, X may be in the range of about 7 to about 12, and Y may be in the range of about 3 to about 15. In various embodiments, X may be in the range of about 7 to about 12, and Y may be in the range of about 3 to about 15, and the catalyst comprises an amount of aluminum greater than or equal to the amount of cobalt.

In various embodiments, X may be in the range of about 8 to about 20, and Y may be in the range of about 3 to about 15. In various embodiments, X may be in the range of about 8 to about 20, and Y may be in the range of about 3 to about 15, and the catalyst comprises an amount of aluminum greater than or equal to the amount of cobalt.

In various embodiments, X may be in the range of about 7 to about 20, and Y may be in the range of about 2 to about 19. In various embodiments, X may be in the range of about 7 to about 20, and Y may be in the range of about 2 to about 19, and the catalyst comprises an amount of aluminum greater than or equal to the amount of cobalt.

In various embodiments, the elemental ratio of aluminum to cobalt to copper may be: about 80:39:1, about 24:5:1, about 1.5:2:1, about 2.2:2:1, about 4:1:1, about 2.33:3.33:1, about 3:1.6:1, about 3:2.5:1, about 12:2:1, about 8:1:1, about 4:2:1, about 6:23:1, about 40:19:1, about 3:2:1, about 5:9:1, about 6.67:2.33:1, about 6:8:1, about 6:2:1, about 5:4:1, about 10:19:1, about 6:2.7:1, about 10:4:1, about 20:9:1, about 14:15:1, about 9:5:1, about 16:13:1, about 7:7:1, about 12:3.4:1, about 9.5:4.5:1, about 18:11:1, about 12:7:1 or about 8:6:1.

In various embodiments, the elemental ratio of aluminum to cobalt to copper may be: about 6.67:2.33:1, about 6:8:1, about 6:2:1, about 5:4:1, about 10:19:1, about 6:2.7:1, about 10:4:1, about 20:9:1, about 14:15:1, about 9:5:1, about 16:13:1, about 7:7:1, about 12:3.4:1, about 9.5:4.5:1, about 18:11:1, about 12:7:1 or about 8:6:1.

In various embodiments, the elemental ratio of aluminum to cobalt to copper may be about 10:4:1, about 20:9:1, about 14:15:1, about 9:5:1, about 16:13:1, about 7:7:1, about 12:3.4:1, about 9.5:4.5:1, about 18:11:1, about 12:7:1 or about 8:6:1.

In various embodiments, the elemental ratio of aluminum to cobalt to copper may be about 16:13:1, about 7:7:1, about 12:3.4:1, about 9.5:4.5:1, about 18:11:1, about 12:7:1 or about 8:6:1.

In various embodiments, the mixed metal oxide catalyst may further comprise a carrier material.

In various embodiments, Cu⁺² and Co⁺² ions may share the A site of the spinel type structure; and Co⁺³ and Al⁺³ ions may share the B site of the spinel type structure.

In various embodiments, the X-ray diffraction pattern of the mixed metal oxide catalyst may be absent peaks associated with gamma alumina.

In various embodiments, the mixed metal oxide catalyst may further comprise a precious metal, or a rare earth element.

In various embodiments, the mixed metal oxide catalyst may further comprise a dopant.

In various embodiments, the dopant may be substituted for about an equal molar amount of cobalt.

In various embodiments, the dopant may be substituted at about 0.1% to about 20%.

In various embodiments, the dopant may comprise cerium and/or manganese.

In various embodiments, there is provided herein a catalyst prepared using a mixed metal oxide composition or catalyst precursor as described herein.

In various embodiments, the carrier material may be uniformly dispersed in the composition or catalyst precursor, or the composition or catalyst precursor may be uniformly dispersed on the carrier material.

In various embodiments, the composition or catalyst precursor may be deposited on a base layer of the carrier material.

In various embodiments, the carrier material may be added into the composition or catalyst precursor prior to dispersal.

In various embodiments, the composition or catalyst precursor may be applied to a substrate.

In various embodiments, the substrate may be porous.

In various embodiments, the substrate may comprise cordierite, alumina, zirconia, magnesium oxide, metal honeycombs, or ceramic beads.

In various embodiments, applying to the substrate may comprise coating the substrate such that the composition or catalyst precursor may be uniformly distributed on the substrate.

In various embodiments, the coating may comprise filling the pores of the substrate.

In various embodiments, the total loaded composition may be between about 10% and about 150% by weight of the total catalyst weight.

In various embodiments, the total loaded composition may be between about 40% and about 60% by weight of the total catalyst weight.

In various embodiments, applying to the substrate may comprise submerging the substrate in a dispersion of the composition or catalyst precursor.

In various embodiments, the reaction initialization temperature for use of the mixed metal oxide catalyst may be less than about 350° C.

In various embodiments, the catalyst may be for use in a catalytic converter.

In another aspect of the disclosure, there is provided herein a method to remove one or more pollutants from a gas stream that comprises exposing the gas stream to a catalyst as described herein.

In various embodiments, the gas stream may comprise a gas stream, an exhaust gas stream, flue gas, flue exhaust, diesel exhaust, kerosene exhaust, or any combination thereof.

In various embodiments, the pollutant may comprise carbon monoxide, nitrogen oxides, hydrocarbons, or any combination thereof.

In various embodiments, exposing the gas stream to the catalyst may be at an operating temperature of between about 300° C. and about 700° C.

In various embodiments, the reaction initiation temperature for catalysis using the catalyst may be less than about 350° C.

In another aspect of the disclosure, there is provided herein a process for preparing a catalyst that comprises: (a) preparing a dispersion comprising a metal solution, wherein the metal solution comprises a solvent, and aluminium, copper and cobalt in solution, wherein the total concentration of metal ions in the solution may be between about 0.5 M and about 5 M; (b) applying the dispersion to a substrate; (c) removing the solvent from the substrate to form a catalyst precursor or composition; and (d) calcining the catalyst precursor or composition to produce the catalyst, wherein the catalyst comprises an elemental ratio of aluminum to cobalt to copper of X:Y:1, wherein X may be in the range of about 1 to about 80, and Y may be in the range of about 1 to about 39.

In various embodiments, X is in the range of about 5 to about 20, and Y is in the range of about 2 to about 19. In various embodiments, X is in the range of about 5 to about 20, and Y is in the range of about 2 to about 19, and the amount of aluminum is greater than or equal to the amount of cobalt.

In various embodiments, X is in the range of about 7 to about 20, and Y is in the range of about 3 to about 15. In various embodiments, X is in the range of about 7 to about 20, and Y is in the range of about 3 to about 15, and the amount of aluminum is greater than or equal to the amount of cobalt.

In various embodiments, X is in the range of about 7 to about 18, and Y is in the range of about 3 to about 13. In various embodiments, X is in the range of about 7 to about 18, and Y is in the range of about 3 to about 13, and the amount of aluminum is greater than or equal to the amount of cobalt.

In various embodiments, X is in the range of about 8 to about 20, and Y is in the range of about 3 to about 15. In various embodiments, X is in the range of about 8 to about 20, and Y is in the range of about 3 to about 15, and the amount of aluminum is greater than or equal to the amount of cobalt.

In various embodiments, X is in the range of about 7 to about 20, and Y is in the range of about 3 to about 15. In various embodiments, X is in the range of about 7 to about 20, and Y is in the range of about 3 to about 15, and the amount of aluminum is greater than or equal to the amount of cobalt.

In various embodiments, X is in the range of about 7 to about 20, and Y is in the range of about 2 to about 19. In various embodiments, X is in the range of about 7 to about 20, and Y is in the range of about 2 to about 19, and the amount of aluminum is greater than or equal to the amount of cobalt.

In various embodiments, the elemental ratio of aluminum to cobalt to copper may be: about 80:39:1, about 24:5:1, about 1.5:2:1, about 2.2:2:1, about 4:1:1, about 2.33:3.33:1, about 3:1.6:1, about 3:2.5:1, about 12:2:1, about 8:1:1, about 4:2:1, about 6:23:1, about 40:19:1, about 3:2:1, about 5:9:1, about 6.67:2.33:1, about 6:8:1, about 6:2:1, about 5:4:1, about 10:19:1, about 6:2.7:1, about 10:4:1, about 20:9:1, about 14:15:1, about 9:5:1, about 16:13:1, about 7:7:1, about 12:3.4:1, about 9.5:4.5:1, about 18:11:1, about 12:7:1 or about 8:6:1.

In various embodiments, the elemental ratio of aluminum to cobalt to copper may be: about 6.67:2.33:1, about 6:8:1, about 6:2:1, about 5:4:1, about 10:19:1, about 6:2.7:1, about 10:4:1, about 20:9:1, about 14:15:1, about 9:5:1, about 16:13:1, about 7:7:1, about 12:3.4:1, about 9.5:4.5:1, about 18:11:1, about 12:7:1 or about 8:6:1.

In various embodiments, the elemental ratio of aluminum to cobalt to copper may be: about 10:4:1, about 20:9:1, about 14:15:1, about 9:5:1, about 16:13:1, about 7:7:1, about 12:3.4:1, about 9.5:4.5:1, about 18:11:1, about 12:7:1 or about 8:6:1.

In various embodiments, the elemental ratio of aluminum to cobalt to copper may be: about 16:13:1, about 7:7:1, about 12:3.4:1, about 9.5:4.5:1, about 18:11:1, about 12:7:1 or about 8:6:1.

In various embodiments, the aluminum, copper and cobalt in the metal solution may each independently be an oxide, a salt, an organometallic complex, or any combination thereof.

In various embodiments, the aluminum, copper and cobalt salts may be aluminum nitrate, copper nitrate and cobalt nitrate.

In various embodiments, the catalyst precursor may further comprise a carrier material.

In various embodiments, the carrier material may be added to the dispersion during step (a).

In various embodiments, the step of applying the dispersion to the substrate may comprise uniformly distributing the dispersion on the substrate.

In various embodiments, the substrate may be porous.

In various embodiments, the step of applying may comprise filling the pores of the substrate.

In various embodiments, the step of applying may comprise submerging the substrate in the dispersion.

In an embodiment, the substrate may comprise cordierite, alumina, zirconia, magnesium oxide, metal honeycombs, or ceramic beads.

In various embodiments, the total loaded dispersion may be between about 10% and about 150% by weight of the catalyst.

In various embodiments, the total loaded dispersion may be between about 40% and about 60% by weight of the catalyst.

In various embodiments, the solvent may comprise water or acetone.

In various embodiments, the step of removing the solvent from the substrate to form the catalyst precursor may comprise evaporating the solvent.

In various embodiments, the step of removing the solvent from the substrate to form the catalyst precursor may further comprise rolling the substrate.

In various embodiments, the step of calcining the catalyst precursor may comprise a temperature of between about 800° C. and about 1000° C. for about 10 minutes to about 60 minutes.

In various embodiments, the step of calcining may occur in air.

In various embodiments, steps (b) to (d) may be repeated one or more times to produce the catalyst.

In various embodiments, the catalyst may be used as a catalytic converter.

Other aspects and features of the present disclosure will become apparent to those of ordinary skill in the art upon review of the following description of specific embodiments of the disclosure in conjunction with the accompanying claims.

### BRIEF DESCRIPTION OF THE DRAWINGS

In drawings which illustrate embodiments of the disclosure,

FIG. 1 provides the NO_{X} conversion percentage across a range of lambda values for mixed metal oxide catalysts according to various embodiments of the disclosure;

FIG. 2 provides the NO_{X} conversion percentage across a range of lambda values for mixed metal oxide catalysts according to an embodiments of the disclosure;

FIG. 3 provides an illustration of relative performance of various mixed metal oxide catalysts comprising various ratios of Al:Co:Cu;

FIG. 4 shows a flow diagram of an embodiment of a process as described herein, which may be performed to obtain a mixed metal oxide catalyst as described herein; and

FIG. 5 provides the NO_{X} conversion percentage at 0.995 lambda for mixed metal oxide catalysts comprising a dopant according to embodiments of the disclosure.

### DETAILED DESCRIPTION

In the context of the present disclosure, various terms are used in accordance with what is understood to be the ordinary meaning of those terms.

Described herein are mixed metal oxide compositions or catalyst precursors and mixed metal oxide catalysts, as well as processes for the preparation thereof. It will be appreciated that embodiments and examples are provided herein for illustrative purposes intended for those skilled in the art, and are not meant to be limiting in any way.

As used herein, the term “about” refers to an approximately +/−10% variation from a given value. It is to be understood that such a variation is always included in any given value provided herein, whether or not it is specifically referred to.

As used herein, the term “substantially” refers to an approximately +/−5% variation from a given value. If a value is not used, then substantially means almost completely, but perhaps with some variation, contamination and/or additional component. In some embodiments, “substantially” may include completely.

As used herein, the term “catalyst” may refer to any material that increases the rate at which a reaction occurs. Catalysts are not consumed in the reaction, but may be altered by the reaction. Catalysts generally react with one or more reactants to form intermediates that subsequently give the final reaction product. The catalyst may be a catalyst appropriate for use in an engine, such as an internal combustion engine, to catalyze the reaction of harmful emissions, such as NO_{X}, CO, and hydrocarbons, to produce less harmful emissions such as nitrogen, oxygen, and carbon dioxide. It is contemplated that the catalyst may be present in other engines, machines, technologies or the like, in order to reduce harmful emissions.

As used herein, the term “properties”, in reference to the function of a mixed metal oxide catalyst may include, but is not limited to, one or more of: increased stability, increased longevity, increased emission reduction, increased NO_{X} reduction, increased CO reduction, increased hydrocarbon reduction, improved operating temperature, increased oxidation potential, increased reduction potential, lower reaction initialization temperature, increased lean fuel emission reduction, increased rich fuel emission reduction, increased emission reduction across a range of lambda values, increased emission reduction across a range of lambda values near 1, ease of production, decreased quantity of the composition of catalyst required for use, increased utility across a range of lambda values, and lower cost of production. It is contemplated that the recitation of “properties” in reference to the function of a mixed metal oxide catalyst may encompass one or more of any of these properties, whether or not they are each individually recited.

As used herein, the term “gas” may comprise a phase of matter and/or a combustible fuel used to generate energy, such as for example, gasoline, diesel, kerosene, propane or other combustible fuel.

### Compositions and Catalysts

In various embodiments as disclosed herein, there is provided mixed metal oxide catalysts comprising aluminum, cobalt and copper, wherein the elemental ratio of aluminum to cobalt to copper is X:Y:1, wherein X is in the range of about 1 to about 80, and Y is in the range of about 1 to about 39, wherein at least a portion of the catalysts comprises a ternary spinel structure.

A mixed metal oxide catalyst refers to a catalyst comprising two or more metal oxides. A metal oxide may comprise a metal and oxygen, and may more specifically comprise a metal cation and an oxide anion. Metal oxides may be formed by a chemical reaction comprising a metal cation and oxygen. The metal cation may be any metal, particularly copper, aluminium, and cobalt, in any cationic form appropriate for applications as defined herein.

As referred to herein, the “elemental ratio” may be defined as the abundance of the metal elements in the composition or catalyst in relation to the other metal element(s) in the composition or catalyst. The abundance of the metal element or quantity of the metal element may be determined using moles, molar ratio, percentage, or any equivalent value in light of the teachings herein. In certain embodiments, the abundance or quantity of the metal element(s) may expressed as its abundance or quantity over a unit area, a surface area, a volume or any equivalent value in light of the teachings herein. As used herein, the elemental form of the metal comprises its form independent of the presence of other molecules, such as for example, Al³⁺, Cu²⁺, or Co²⁺, which may be covalently or non-covalently bound to other chemicals or molecules. As such, the ratio may refer to the quantity of the metal independently of additional groups, such as an oxide, nitrate or other additional elements or molecules, relative to other metals in the mixed metal oxide composition or catalyst.

In certain embodiments, the mixed metal oxide composition or catalyst may comprise aluminum, cobalt and copper, wherein the elemental ratio of aluminum to cobalt to copper is X:Y:1, wherein X is in the range of about 1 to about 80, and Y is in the range of about 1 to about 39. In certain embodiments, the metal element copper may be assigned a value of 1 in the ratio of the mixed metal oxide composition or catalyst. The value of 1 for copper in the ratio, as would be known to a person of skill in the art, provides a means of normalizing the quantities of other metal elements present in the composition or catalyst. The value of 1 in a ratio may not correspond substantially to the absolute quantity of the element, but refers to its quantity in relation to other metal element(s) comprised in the composition or catalyst. In certain embodiments, copper may independently be present in an equal or a lesser amount than the cobalt or the aluminum. In certain further embodiments, the composition or the catalyst may comprise an amount of aluminum greater than or equal to the amount of cobalt. In certain embodiments, it is contemplated that each of metal element X and Y may independently represent any value recited in the ratio therein, such that X may independently comprise any value between about 1 and about 80, and Y may independently comprise any value between about 1 and about 39. In certain embodiments, the value of X may independently be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80, and the value of Y may independently be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, or 39. In certain embodiments, X may be in the range of 7 to 12 and Y may be in the range of 3 to 15. In certain embodiments, X may be in the range of 7 to 18 and Y may be in the range of 3 to 13. In certain embodiments, X may be in the range of 5 to 20 and Y may be in the range of 2 to 19. In certain embodiments, X may be in the range of 8 to 20 and Y may be in the range of 3 to 15. In certain embodiments, X may be in the range of 7 to 20 and Y may be in the range of 3 to 15. In certain embodiments, X may be in the range of 7 to 20 and Y may be in the range of 2 to 19. In certain embodiments, the elemental ratio of aluminum to cobalt to copper may be: about 80:39:1, about 24:5:1, about 1.5:2:1, about 2.2:2:1, about 4:1:1, about 2.33:3.33:1, about 3:1.6:1, about 3:2.5:1, about 12:2:1, about 8:1:1, about 4:2:1, about 6:23:1, about 40:19:1, about 3:2:1, about 5:9:1, about 6.67:2.33:1, about 6:8:1, about 6:2:1, about 5:4:1, about 10:19:1, about 6:2.7:1, about 10:4:1, about 20:9:1, about 14:15:1, about 9:5:1, about 16:13:1, about 7:7:1, about 12:3.4:1, about 9.5:4.5:1, about 18:11:1, about 12:7:1 or about 8:6:1. In certain embodiments, the mixed metal oxide composition or catalyst may comprise aluminum, cobalt and copper, wherein the elemental ratio of aluminum to cobalt to copper may be X:Y:1, wherein X is not in the range of about 1 to about 3, and Y is not in the range of about 1.4 to about 6.

In certain embodiments, the mixed metal oxide composition or catalyst may comprise metal oxides of aluminum, cobalt and copper. The mixed metal oxide catalyst may be substantially in a solid form, wherein the solid form may comprise a crystalline solid or any equivalent solid known to the person of skill in the art in light of the teachings herein. A crystalline solid comprises a solid structure in which the molecules forming the crystalline solid may be in a well-defined arrangement. In certain embodiments, the crystalline solid may at least partially comprise a ternary spinel structure. A spinel structure is a crystal structure with the general formula AB₂X₄ where A and B are cations and X is an anion. The spinel structure has a face-centered cubic closed packed array of 32 anions in which the interstices are occupied by metal ions. As used herein, a spinel structure may refer to a spinel structure, a spinel-like structure, or any equivalent known to a person of skill in the art. In certain embodiments, the octahedral site of the spinel may be designated as the B-site and the tetrahedral site of the spinel may be designated as the A-site. In certain embodiments, the Cu²⁺ and Co²⁺ ions may share the A-site in the spinel structure, and the Co³⁺ and Al³⁺ ions may share the B site of the spinel structure, which may be represented by the chemical formula (CuCo)(CoAl)₂O₄. In certain embodiments, the catalyst may comprise additional crystalline or non-crystalline portions.

As would be known to a person of skill in the art, a spinel structure may be determined using a variety of techniques, including, but not limited to, X-ray diffraction, tunneling electron microscopy or photoelectron spectroscopy. In certain embodiments, the catalyst may be absent X-ray diffraction peaks associated with gamma alumina. In certain embodiments, the spinel type structure of the catalyst may be characterized by an X-ray diffraction pattern without a peak at {222}. In certain embodiments, the spinel type structure of the catalyst may be characterized by an X-ray diffraction pattern with a low intensity ratio of the {222} peak to the {311} peak. In certain embodiments, the ratio of the {222} peak to the {311} peak of the catalyst may be less than about 0.1.

In certain embodiments, the composition or catalyst may further comprise a carrier material. The carrier material, as used herein, may be used to disperse the composition or the catalyst. The carrier material may disperse the composition or catalyst over a large surface area. The carrier material may be selected to provide a rough or irregular surface, which may increase the surface area in comparison with a smooth surface or a surface not comprising a carrier material. The carrier material may also influence the performance of the catalyst, such as, for example, the performance at specific temperatures and the long-term stability of the catalyst. The carrier material may also provide oxygen storage and release, which may improve the performance of the catalyst during lean fuel and rich fuel operation of the engine. The selection of a catalyst that is more stable and durable may be advantageous, as these properties may provide for mounting of the catalyst or providing the catalyst closer to the engine and/or increasing the life of the catalyst. In certain embodiments herein, the carrier material may comprise alumina, silica, titania, zirconia, yttrium-stabilized zirconia, zirconium oxide, any carrier known to a person of skill in the art, in light of the teachings herein, or any combination thereof.

In certain embodiments, the composition or catalyst may further comprise a precious metal, or a rare earth element. As used herein a “precious metal” may refer to any naturally occurring metallic chemical element with a current high economic value, such as, for example, rhodium, platinum, gold, palladium, iridium, osmium, rhenium, ruthenium, germanium, beryllium, silver, indium, gallium, tellurium, bismuth, or mercury, in comparison with other metallic chemical elements. As used herein, a “rare earth element” may refer to elements comprising scandium, yttrium, lanthanum, praseodymium, neodymium, promethium, samarium, europium, gadolinium, terbium, dysprosium, holmium, erbium, thulium, ytterbium, and lutetium.

In certain embodiments, the composition or catalyst may further comprise a dopant. The term “dopant” or “doping agent”, as used herein, may refer to an element introduced into a material, such as a composition or catalyst, which alters its properties. In certain embodiments, the dopant may alter one or more of the following properties of the composition or catalyst to which it may be added, including, but not limited to: increased stability, increased longevity, increased emission reduction, increased NO_{X} reduction, increased CO reduction, increased hydrocarbon reduction, improved operating temperature, increased oxidation potential, increased reduction potential, lower reaction initialization temperature, increased lean fuel emission reduction, increased rich fuel emission reduction, ease of production, decreased quantity of the composition of catalyst used, and/or lower cost of production. In certain embodiments, the dopant may comprise any trace material that alters at least a property of the composition or catalyst. In certain embodiments, the dopants may comprise cerium, manganese, or any combination thereof. In certain embodiments, the amount of the dopant added to the composition or catalyst to alter its properties may be very low. In certain embodiments, the dopant may be substituted for an equal molar amount of a metal in the composition or catalyst. For example, the dopant may be substituted at about 0.1% to about 20%, or any value there between. In certain embodiments, the dopant may be substituted at 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, 4.9%, 5%, 5.1%, 5.2%, 5.3%, 5.4%, 5.5%, 5.6%, 5.7%, 5.8%, 5.9%, 6%, 6.1%, 6.2%, 6.3%, 6.4%, 6.5%, 6.6%, 6.7%, 6.8%, 6.9%, 7%, 7.1%, 7.2%, 7.3%, 7.4%, 7.5%, 7.6%, 7.7%, 7.8%, 7.9%, 8%, 8.1%, 8.2%, 8.3%, 8.4%, 8.5%, 8.6%, 8.7%, 8.8%, 8.9%, 9%, 9.1%, 9.2%, 9.3%, 9.4%, 9.5%, 9.6%, 9.7%, 9.8%, 9.9%, 10%, 10.1%, 10.2%, 10.3%, 10.4%, 10.5%, 10.6%, 10.7%, 10.8%, 10.9%, 11%, 11.1%, 11.2%, 11.3%, 11.4%, 11.5%, 11.6%, 11.7%, 11.8%, 11.9%, 12%, 12.1%, 12.2%, 12.3%, 12.4%, 12.5%, 12.6%, 12.7%, 12.8%, 12.9%, 13%, 13.1%, 13.2%, 13.3%, 13.4%, 13.5%, 13.6%, 13.7%, 13.8%, 13.9%, 14%, 14.1%, 14.2%, 14.3%, 14.4%, 14.5%, 14.6%, 14.7%, 14.8%, 14.9%, 15%, 15.1%, 15.2%, 15.3%, 15.4%, 15.5%, 15.6%, 15.7%, 15.8%, 15.9%, 16%, 16.1%, 16.2%, 16.3%, 16.4%, 16.5%, 16.6%, 16.7%, 16.8%, 16.9%, 17%, 17.1%, 17.2%, 17.3%, 17.4%, 17.5%, 17.6%, 17.7%, 17.8%, 17.9%, 18%, 18.1%, 18.2%, 18.3%, 18.4%, 18.5%, 18.6%, 18.7%, 18.8%, 18.9%, 19%, 19.1%, 19.2%, 19.3%, 19.4%, 19.5%, 19.6%, 19.7%, 19.8%, 19.9%, 20%, or any value there between. In various embodiments, the dopant may be substituted at about 0.1% to about 2%, or any value therebetween.

In certain further embodiments, the dopant may be substituted for an equal molar amount of cobalt, such that removing, for example, 1% cobalt would require the addition of 1% dopant. In certain embodiments, it is contemplated that one or more dopants are added to the mixed metal oxide composition or catalyst. In certain embodiments, the dopant may improve one or more properties of the mixed metal oxide composition or catalyst.

In certain embodiments, a mixed metal oxide composition or catalyst precursor as described herein may be used to prepare a catalyst. The catalyst may catalyze reactions, such as those which decrease harmful emissions, such as, for example, CO, NO_{X} and hydrocarbons emission from an internal combustion engine. The catalyst may catalyze reduction reactions, such as the reaction of NO_{X} to form nitrogen. The catalyst may catalyze oxidation reactions, such as the reaction of CO or hydrocarbons to form water and CO₂. The catalyst may be used in combination with an engine, such as an internal combustion engine, to reduce the amount of one or more emissions, such as NO_{X}, CO, and hydrocarbons.

In certain embodiments, the carrier material may be uniformly dispersed in the composition or dispersion, or the composition or dispersion may be uniformly dispersed on the carrier material. As used herein, the term “uniform” may refer to a substantially equal distribution of one feature, such as a composition, on another feature, such as a carrier material. In certain embodiments, the composition or dispersion may be deposited, applied or coated on a base layer of the carrier material. The “base layer”, as used herein, may refer to a surface, such as a carrier material, which may be substantially solid and may be capable of receiving a mixed metal oxide composition or dispersion. In certain other embodiments, the carrier material may be added to the composition or dispersion prior to dispersal, such that the carrier material and composition or dispersion are uniformly distributed within each other, such that their dispersal may result in simultaneous uniform distribution of the composition or catalyst and the carrier material. Non-uniform distribution of the carrier material and/or the composition or dispersion may result in inconsistent function across the catalyst or composition, such that some areas may perform poorly in comparison to other areas on the same carrier material, catalyst or composition.

In certain embodiments, the composition or dispersion may be applied to a substrate. The substrate, as would be known to a person of skill in the art, may comprise any substrate appropriate for the catalyst based on its application or intended use. In certain embodiments, the substrate may comprise a carrier material. In certain embodiments, the substrate may comprise cordierite, alumina, zirconia, magnesium oxide, metal honeycombs, or ceramic beads. In certain embodiments, the composition or dispersion may be applied to the substrate, such that the composition or dispersion may be uniformly distributed on the substrate. In certain embodiments, the substrate may be porous. The use of a porous substrate may increase the surface area of the catalyst, which may improve one or more properties of the catalyst, including, but not limited to, increased emission reduction, increased longevity, decreased cost of preparation and/or increased stability. In certain embodiments, the composition or dispersion may be applied to the substrate, such that the composition may be uniformly distributed on the substrate. In certain embodiments, the substrate may be coated with the composition or dispersion. The term “coating” as used herein may comprise applying a material, for example, a composition, such that it may be uniformly distributed on a surface, such as for example, a substrate. Non-uniform application or coating of the composition on the substrate may result in inconsistent properties across the coated substrate. In certain embodiments, coating the substrate with the composition or dispersion may comprise filling the pores of the substrate, wherein filling may comprise a substantially complete and uniform application of the composition or dispersion in the pores of the substrate. In certain embodiments, the substrate may be submerged in a dispersion of the composition. Submerging, or surrounding the substrate in the dispersal of the composition, may result in uniform application of the composition on the substrate, and/or filling the pores of the substrate with the composition.

In certain embodiments, the composition may comprise a defined weight of the total catalyst. In certain embodiments, the total loaded composition or dispersion may be between about 10% and about 150% by weight of the total catalyst weight, or any amount therebetween. In certain further embodiments, the total loaded composition or dispersion may be between about 40% and about 60% by weight of the total catalyst weight. As used herein the “total loaded composition” or “total loaded dispersion” may refer to the amount by weight of the composition applied, coated or loaded, onto the substrate or carrier material to provide the catalyst. The “total catalyst weight” may refer to the weight of any combination of elements in the catalyst, including, but not limited to: the composition, carrier material, substrate, rare earth elements, dopant, and/or precious metals in the catalyst. In certain embodiments, the composition may be applied to the substrate with a weight loading from greater than 0% to about 300%, as desired to achieve the desired mixed metal oxide composition or catalyst. The total loaded composition applied or coated onto the substrate may be altered by varying the ratio of starting metal material to solvent level to yield the desired total loaded composition. In certain embodiments, the total loaded composition applied or coated onto the substrate may be altered by repeating the steps of applying, removing and calcining to yield the desired total loaded catalyst.

A person of skill in the art would appreciate that the function of catalysts, such as those used in engines including internal combustion engines, may be dependent on the temperatures at which the catalysis is performed. Catalysts, such as those present in internal combustion engines, may comprise a reaction initialization temperature and an operating temperature. The reaction initialization temperature may refer to the temperature at which the catalysis reaction starts, or the temperature at which catalysis starts at a significant rate. The person of skill in the art would appreciate that some catalysts, such as those used in internal combustion engines, may have a high reaction initialization temperature, such as for example, greater than 350° C. A lower reaction initialization temperature may result in the initiation of catalysis earlier than a catalyst with a higher reaction initialization temperature, such that the catalyst with the lower reaction initialization temperature may initiate catalysis earlier, resulting in a longer period of catalysis, which may result in a higher proportion of harmful emissions converted into less harmful emissions. In certain embodiments, the catalyst or composition may comprise a reaction initialization temperature below about 400° C., below about 350° C., below about 300° C. or below about 250° C. The operating temperature, as used herein, may refer to the temperature at which the catalyst substantially operates after reaching or exceeding the reaction initialization temperature or the light-off temperature. The use of lower operating temperatures may improve one or more properties of the catalyst, including, but not limited to: increased stability, increased longevity, and increased emission reduction. In certain embodiments, the operating temperature of the catalyst or composition may be between about 300° C. and about 700° C.

In certain embodiments described herein, the catalyst may be used in a catalytic converter. As used herein, a “catalytic converter” is an emission control device that converts toxic gases, such as pollutants including NO_{X}, CO, and hydrocarbons, from engines, such as internal combustion engines, into less harmful products. The catalytic converter may function by catalyzing oxidation and/or reduction reactions with the toxic gases to increase the formation of less harmful products. In certain embodiments, the catalytic converter may be a three-way catalytic converter, wherein the three-way catalytic converter may control the emissions of NO_{X}, CO and hydrocarbons in a single catalytic converter. In certain embodiments, it is contemplated that the catalytic converter may comprise one or more zones of catalysis, or the catalysis may occur in one or more catalytic converters described herein operably connected to an internal combustion engine.

In certain embodiments, it is contemplated that the catalyst may have substantially improved ability to reduce harmful emissions across a range of lambda values. As used herein “lambda” or “lambda values” may refer to the air to fuel ratio, wherein a value of 1 may represent stoichiometric, wherein the exact amount of air (or oxygen) is present to burn the fuel. Values greater than 1 may indicate an excess of air (or oxygen) and values less than 1 may indicate an excess of fuel. In various embodiments, the catalysts or compositions as described herein may be used at lambda values of 0.995 to 0.998, a range at which prior art catalysts have shown low NO_{X} conversion. In certain embodiments, the mixed metal oxide catalysts may reduce NO_{X}, CO and/or hydrocarbon emissions at levels greater than other technologies known in the art. In certain embodiments, the mixed metal oxide catalyst may reduce NO_{X} levels greater than other technologies known in the art. In certain embodiments, the mixed metal oxide catalysts may reduce NO_{X} levels greater than other technologies known in the art across a range of lambda values. In certain embodiments, the mixed metal oxide composition may reduce NO_{X}, CO and HC levels greater than other technologies known in the art across a range of lambda values.

Oxidation reactions, such as those converting CO and hydrocarbons to less harmful emission in a catalytic converter, may proceed substantially efficiently in lean-fuel conditions, or lambda values more than 1. For rich fuel conditions or lambda values less than 1, the catalysis of reduction reactions, such as the conversion of NO_{X} to nitrogen, may be improved through use of the catalysts or compositions as described herein.

### Methods

In various embodiments, there is provided herein a method to remove one or more pollutants from a gas stream comprising exposing the gas stream to a mixed metal oxide catalyst described herein. As used herein, the term “remove” may refer to the complete elimination of one or more pollutants, a substantial decrease in the one or more pollutants, or a substantial decrease in the one or more pollutants as compared to conventional catalysts, compositions or technologies. As used herein, the term “pollutant” may comprise any toxic or harmful emission created because of the operating or the use of a technology or machine, such as an engine. In certain embodiments, the pollutant may comprise an emission, a toxic emission, a harmful emission, or any equivalent term known to the person of skill in the art in light of the teachings herein. A pollutant may comprise one or more emissions comprising NO_{X}, carbon monoxide, hydrocarbons, particulate matter, sulfur dioxide or volatile organic compounds. A “gas stream”, as used herein, may describe a continuous flow of a gas, inputted or outputted, during the combustion of fuel to produce energy. In certain embodiments, the gas stream may comprise a gas stream, an exhaust gas stream, a flue gas stream, a diesel stream, a kerosene stream, or any combination thereof. A person of skill in the art, in light of the teachings herein, would be able to select an appropriate method to expose the gas stream to the catalyst, including, but not limited to, passing the gas stream through a catalytic converter. Increasing the area of the catalytic converter to which the gas stream is exposed may improve the reduction of harmful pollutants.

In certain embodiments, the gas stream may be exposed to the catalyst at an operating temperature. In certain embodiments, the exposing of the gas stream to the composition or catalyst may occur at an operating temperature of between about 300° C. and about 700° C. Performing the method with a lower operating temperature may improve properties such as stability or longevity of the composition or catalyst.

In certain embodiments, the reaction initiation temperature for catalysis of the catalyst may be less than about 350° C. In various embodiments, performing a method with a catalyst having a lower reaction initialization temperature may have advantages over performing the method with a catalyst or composition comprising a higher reaction initialization temperature, as described above.

### Processes

Reference will now be made in detail to exemplary embodiments of the disclosure, wherein numerals refer to like components, examples of which are illustrated in the accompanying drawings that further show exemplary embodiments, without limitation.

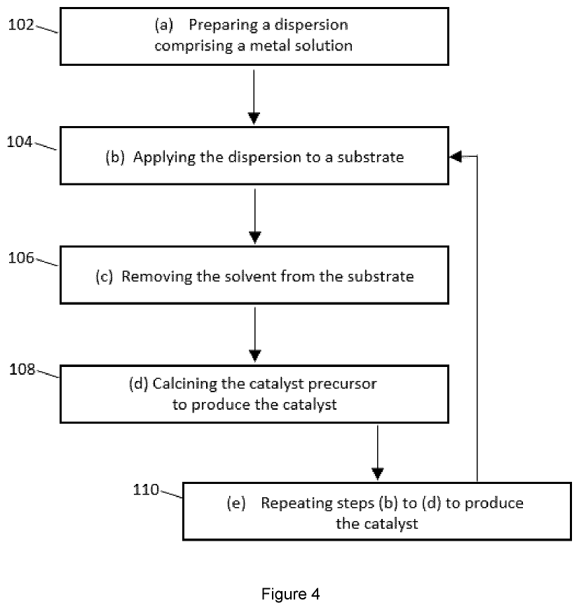

In an embodiment and as shown in FIG. 4, there is provided herein a process for preparing a mixed metal oxide catalyst comprising: (a) preparing a dispersion comprising a metal solution 102, wherein the metal solution may comprise a solvent, and aluminium, copper and cobalt in solution, wherein the total concentration of metal ions in the solution may be between about 0.5 M and about 5 M; (b) applying the dispersion to a substrate 104; (c) removing the solvent from the substrate to form a catalyst precursor 106; and (d) calcining the catalyst precursor to produce the catalyst 108, wherein the catalyst comprises an elemental ratio of aluminum to cobalt to copper of X:Y:1, wherein X may be in the range of about 1 to about 80, and Y may be in the range of about 1 to about 39.

As described herein, the dispersion comprises a solution comprising metal ions. In certain embodiments, the solution may comprise a wash coat. The metal ions may be prepared by mixing or dissolving with a solvent. A person of skill in the art, in light of the teachings herein, would be able to select an appropriate solvent for the metal containing compound or chemical for the production of a catalyst described herein. In certain embodiments, the solvent may comprise water and/or acetone.

In certain embodiments, the total concentration of metal ions in the solution may be between about 0.5 M and about 5 M, or any amount therebetween. In certain further embodiments, the total concentration of metal ions in the solution may be between about 1 M and about 3 M, between about 1.5 M and about 2.5 M, or between about 1.7 M and about 2.3 M. As used herein, the “total concentration of metal ions” may refer to the combined concentration of each metal ion in the solution, such as for example, a solution comprising about 0.5 M of each of copper, aluminum, and cobalt would comprise a 1.5M metal solution. In certain embodiments, the concentration of metal ions in the solution may substantially correspond to the final desired ratio of elements and/or weight loading in the mixed metal oxide composition or catalyst. In certain embodiments, the total concentration of metal ions in the solution may be substantially different from the desired ratio of elements and/or weight loading in the mixed metal oxide catalyst. In certain embodiments, the concentration of one or more metal ions in the solution may be substantially different from the desired ratio and/or weight loading and the concentration of one or more metal ions in the solution may substantially correspond to the desired ratio and/or weight loading. However, concentrations of metal ions that are very low may not produce a catalyst with sufficient capacity to perform catalysis reactions to reduce harmful emissions, as the catalyst may not have a sufficient quantity of the metal oxides to perform the oxidation and reduction reactions. Furthermore, sequential repetition of the process using a low concentration metal ion solution may result in unwanted effects, such as impurities and loss of stability, if repeated too many times. Use of high concentrations of metal ions may result in an oversaturated solution, which may not uniformly disperse, coat, or apply to form the catalyst. The use of high concentrations of metal ions may also increase the production cost of the catalyst.

In certain embodiments, the step of applying the dispersion to the substrate 104 may comprise any known technique for the application of the metal solution as described herein, to the substrates as described herein, such as, but not limited to, submerging, painting, or spraying.

In certain embodiments, the step of removing the solvent from the substrate 106 to form a catalyst precursor may comprise evaporating the solvent. In certain embodiments, the step of removing the solvent from the substrate 106 may comprise drying or evaporating the solvent, such that the solvent may be substantially absent from the substrate. A skilled person, in light of the teachings herein, would appreciate that high evaporation temperatures may cause premature oxidation, such as, for example, oxidation of the copper precursors, and may impact the uniform distribution of the precursors or the formation of the desired composition or catalyst. Depending on the elements present in the composition or catalyst, or the quantity of elements, the step of removing the solvent from the substrate 106 may require unique parameters to produce the desired composition and/or catalyst.

The catalyst precursor, as described herein, is the composition containing the desired metal ion(s) before it is converted by calcining to produce the mixed metal oxide catalyst.

The term “calcining” as used herein may refer to a thermal process where a material may be thermally decomposed and/or a volatile fraction may be removed. In certain embodiments, the step of calcining the catalyst precursor to produce the catalyst 108 may be performed in air, or in the presence of oxygen. In certain embodiments, the step of calcining the catalyst precursor to produce the catalyst 108 may be performed at a temperature sufficient to obtain a mixed oxide catalyst at the desired ratio. In certain embodiments, the step of calcining the catalyst precursor to produce the catalyst 108 may comprise a temperature of between about 800° C. and about 1000° C. In certain embodiments, the step of calcining the catalyst precursor to produce the catalyst 108 may comprise a temperature of between about 800° C. and about 900° C. Calcination at higher temperatures, for example greater than 1000° C., may result in the formation of undesirable phases, which may not produce a spinel oxide with the desired ratio of metal oxides. The step of calcining the catalyst precursor to produce the catalyst 108 may be performed in any manner that produces the mixed metal oxide catalyst at the desired ratio. The person of skill in the art would be able to select an appropriate technique, in light of the teachings herein, for calcining the catalyst precursor to produce the catalyst 108 that may minimize undesirable side effects, such as for example, phase separation.

In certain embodiments, each metal oxide in the mixed metal oxide composition or catalyst may be independently prepared using a salt, an oxide, or an organometallic comprising the desired metal cation. In certain embodiments, the mixed metal oxide composition or catalyst may be prepared using metal salts. In certain embodiments, the metal salts may be nitrates, chlorides, acetates, any other soluble metal complexes or combinations thereof. In certain embodiments, the desired ratio of mixed metal oxides in the composition or catalyst may be produced using solid-state synthesis methods, processes or techniques known to the person of skill in the art, including, but not limited to, combining oxides of the metals in the desired ratio.

In certain embodiments, the steps of applying the dispersion to a substrate 104, removing the solvent to produce a catalyst precursor 106, and calcining the catalyst precursor to produce the catalyst 108 may be repeated one or more times to produce the catalyst 110, such as for example, repeating one time, two times, three times, four times, five times, six times, seven times, eight times, nine times or ten times. In certain embodiments, applying the dispersion to a substrate 104, removing the solvent to produce a catalyst precursor 106, and calcining the catalyst precursor to produce the catalyst 108 may be repeated one or more times to produce the catalyst 110 with the desired weight loading. Repeating the steps of applying the dispersion to a substrate 104, removing the solvent to produce a catalyst precursor 106, and calcining the catalyst precursor to produce the catalyst 108, too many times may result in loss of optimal properties of the composition or catalyst, such as for example, the desired ratio, stability, longevity, emission reduction, or may result in the gain of non-optimal properties, such as, for example, impurities.

In certain embodiments, the mixed metal oxide composition and/or catalyst may comprise a dopant. In certain embodiments, the dopant may be added at any point in the process to achieve the desired ratio and utility for the mixed metal oxide composition and/or catalyst. In certain embodiments, the dopant may be added during the step of preparing the dispersion comprising a metal solution 102. In certain embodiments, the dopant may be added to the dispersion prior to applying the dispersion to the substrate 104. In certain embodiments, the dopant may be added after the dispersion is applied to the substrate 104.

### EXAMPLES

The following Examples demonstrate characteristics of selected embodiments, illustrating for example the production and properties of mixed metal oxide compositions and catalysts as described herein. Selected examples are illustrative of advantages that may be obtained compared to alternative methods, and these advantages are accordingly illustrative of particular embodiments and not necessarily indicative of the characteristics of all aspects of the invention.

### Preparation of Mixed Metal Oxide Catalysts

A solution or wash coat of a desired Al:Co:Cu molar ratio was prepared in water with nitrate salts of aluminium, cobalt, and copper, to produce mixed metal oxide catalysts as outlined in Table 1. A total concentration of metal ions in the metal ion solution of between 1.7 M and 1.8 M was used. The wash coat solution was applied to cordierite substrates, dried to remove the solvent, and calcined. The steps of applying, removing the solvent, and calcining were repeated until the substrate contained the desired weight loading of catalyst. In this example, the samples had a catalyst coating between 40 and 90 weight percent. The cordierite substrates measured 25.4 mm long by 19 mm in diameter and had a cell density of 400 Cells per square inch (CPSI).

TABLE 1
Composition of mixed metal oxide catalyst samples

| Sample Number(s) | | | | Al | Co | Cu |
|---|---|---|---|---|---|---|
| 1449-03 | 1449-04 | | | 80 | 39 | 1 |
| 1449-01 | 1449-02 | | | 2 | 1 | 0 |
| 1584-19 | 1584-20 | | | 24 | 5 | 1 |
| 1584-27 | 1584-28 | | | 1.5 | 2 | 1 |
| 1584-29 | 1584-30 | | | 2.2 | 2 | 1 |
| 1449-13 | 1449-14 | | | 4 | 1 | 1 |
| 1584-23 | 1584-24 | | | 2.33 | 3.33 | 1 |
| 1584-31 | 1584-32 | 1584-37 | 1584-38 | 3 | 1.6 | 1 |
| 1584-39 | 1584-40 | | | 3 | 2.5 | 1 |
| 1584-21 | 1584-22 | | | 12 | 2 | 1 |
| 1584-17 | 1584-18 | | | 8 | 1 | 1 |
| 1584-33 | 1584-34 | | | 4 | 2 | 1 |
| 1584-15 | 1584-16 | | | 6 | 23 | 1 |
| 1449-05 | 1449-06 | | | 40 | 19 | 1 |
| 1584-31 | 1584-32 | 1449-15 | 1449-16 | 3 | 2 | 1 |
| 1449-11 | 1449-12 | | | 6.67 | 2.33 | 1 |
| 1584-03 | 1584-04 | | | 5 | 9 | 1 |
| 1584-01 | 1584-02 | | | 6 | 8 | 1 |
| 1584-35 | 1584-36 | | | 6 | 2 | 1 |
| 1584-25 | 1584-26 | | | 5 | 4 | 1 |
| 1584-13 | 1584-14 | | | 10 | 19 | 1 |
| 1449-33 | | | | 6 | 2.7 | 1 |
| 1449-09 | 1449-10 | 1449-25 | 1449-26 | 10 | 4 | 1 |
| 1449-07 | 1449-08 | | | 20 | 9 | 1 |
| 1584-11 | 1584-12 | | | 14 | 15 | 1 |
| 1584-07 | 1584-08 | 1449-19 | | 9 | 5 | 1 |
| 1584-09 | 1584-10 | | | 16 | 13 | 1 |
| 1584-05 | 1584-06 | 1449-23 | 1449-24 | 7 | 7 | 1 |
| 1449-31 | 1449-32 | | | 12 | 3.4 | 1 |
| 1449-18 | | | | 9.5 | 4.5 | 1 |
| 1449-27 | 1449-28 | | | 18 | 11 | 1 |
| 1449-29 | 1449-30 | | | 12 | 7 | 1 |
| 1449-21 | 1449-22 | | | 8 | 6 | 1 |

### Evaluation of the Mixed Metal Oxide Catalysts

The evaluation of the catalysts used a plug flow reactor with a sample inlet temperature controlled to about 450° C. Evaluation of the catalysts was done by determining the effectiveness of the catalysts at removing harmful emissions from gas(es) by measuring the quantity of a gas present either before, during or after fuel combustion in the presence of the catalysts. The gas concentrations were swept from values corresponding to lean lambdas to values corresponding to rich lambdas via scripted changes on a set of mass flow controllers (Alicat MC/MCS series). Gas concentrations were measured with a 5 gas analyzer (FGA4000XDS by Infrared Industries). Each lambda condition was held for 2.5 minutes. The procedure started at lambda 1.005 and proceeded as follows; 1.0, 0.998, 0.995, 0.99, 0.985, and 0.98. The conversion rate was calculated based on the concentration of NO_{X} remaining relative to an initial concentration of NO_{X}.

Samples of gas were prepared by mixing the gas components and then adding 10% water by volume to a 2 standard liter per minute (SLPM) gas flow for a total flow volume of 2.22 SLPM, as shown in, for example, Table 2, and tested at various lambda values.

TABLE 2
Initial Gas Composition at Lambda 0.998 and 0.995

| | | | CO | NO | | H₂ | O₂ |
|---|---|---|---|---|---|---|---|
| Lambda | N₂ | CO₂ | (ppm) | (ppm) | H₂O | (ppm) | (ppm) |
| 0.998 | Balance | 10% | 6240 | 560 | 10% | 1560 | 3095 |
| 0.995 | Balance | 10% | 6240 | 560 | 10% | 1560 | 2730 |

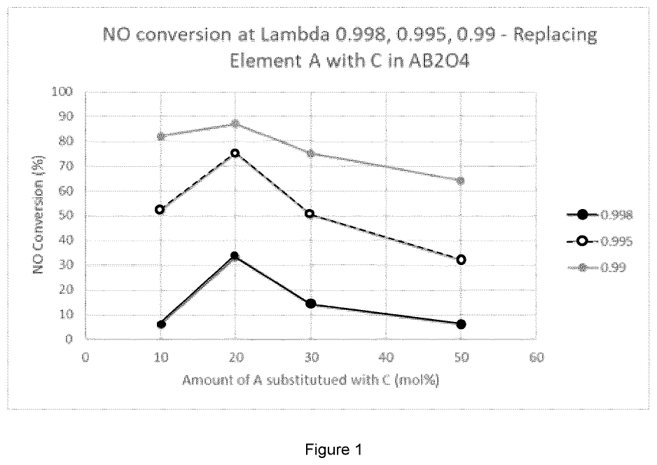

Using a compound of formula CoAl₂O₄, copper was substituted on a molar percent basis (10%, 20%, 30%, 40% and 50%) for cobalt to prepare various mixed metal oxide compositions which in turn were used to produce catalysts as described above. The catalysts were analyzed for NO_{X} conversion at various lambda values (0.998, 0.995 and 0.99 lambda), as shown in FIG. 1. In FIG. 1, Element A is cobalt, Element B is aluminum and Element C is copper. FIG. 1 shows that the catalysts produced from the mixed metal oxide compositions were successful for NO_{X} conversion.

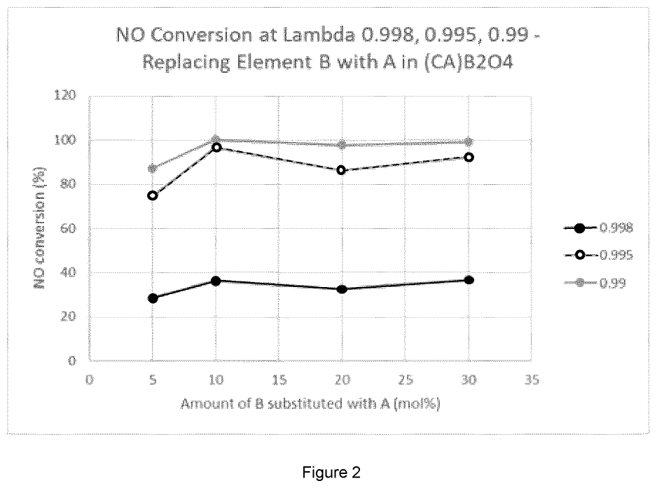

Using a compound of formula (Cu_{0.2}Co_{0.8})Al₂O₄, cobalt was substituted on a molar percent basis for Al (5%, 10%, 20% and 30%) to prepare various mixed metal oxide compositions which in turn were used to produced catalysts as described above. The catalysts were analyzed for NO_{X} conversion at various lambda values (0.998, 0.995 and 0.99 lambda), as shown in FIG. 2. In FIG. 2, Element A is cobalt, Element B is aluminum and Element Cis copper. FIG. 2 shows that the catalysts produced from the mixed metal oxide compositions were successful for NO_{X} conversion.

Using the catalysts from Table 1, the NO_{X} conversion was measured for each same, the conversion data is shown in Table 3.

TABLE 3
NOₓ conversion for mixed metal oxide
catalysts exposed at 0.998 lambda

| | | | | Conversion % of NO_{X} |
|---|---|---|---|---|
| | | | | (Average of the |
| Sample Number(s) | | | | Number of Samples) |
| 1449-03 | 1449-04 | | | −4.932452722 |
| 1449-01 | 1449-02 | | | −4.037103807 |
| 1584-19 | 1584-20 | | | −0.027269951 |
| 1584-27 | 1584-28 | | | 0.181187891 |
| 1584-29 | 1584-30 | | | 0.450437705 |
| 1449-13 | 1449-14 | | | 1.130732841 |
| 1584-23 | 1584-24 | | | 1.286176936 |
| 1584-31 | 1584-32 | 1584-37 | 1584-38 | 1.878669611 |
| 1584-39 | 1584-40 | | | 2.24050197 |
| 1584-21 | 1584-22 | | | 2.56005607 |
| 1584-17 | 1584-18 | | | 3.928552804 |
| 1584-33 | 1584-34 | | | 4.395661248 |
| 1584-15 | 1584-16 | | | 5.110995069 |
| 1449-05 | 1449-06 | | | 6.287946324 |
| 1584-31 | 1584-32 | 1449-15 | 1449-16 | 7.323085269 |
| 1449-11 | 1449-12 | | | 11.24009298 |
| 1584-03 | 1584-04 | | | 13.69925344 |
| 1584-01 | 1584-02 | | | 16.21995533 |
| 1584-35 | 1584-36 | | | 18.48189696 |
| 1584-25 | 1584-26 | | | 19.13231333 |
| 1584-13 | 1584-14 | | | 20.76450992 |
| 1449-33 | | | | 24.86271408 |
| 1449-09 | 1449-10 | 1449-25 | 1449-26 | 27.59028436 |
| 1449-07 | 1449-08 | | | 30.55905753 |
| 1584-11 | 1584-12 | | | 33.36269388 |
| 1584-07 | 1584-08 | 1449-19 | | 33.90080082 |
| 1584-09 | 1584-10 | | | 36.94719965 |
| 1584-05 | 1584-06 | 1449-23 | 1449-24 | 36.99626097 |
| 1449-31 | 1449-32 | | | 37.62677695 |
| 1449-18 | | | | 39.10090624 |
| 1449-27 | 1449-28 | | | 42.66398141 |
| 1449-29 | 1449-30 | | | 50.53522022 |
| 1449-21 | 1449-22 | | | 52.09219386 |

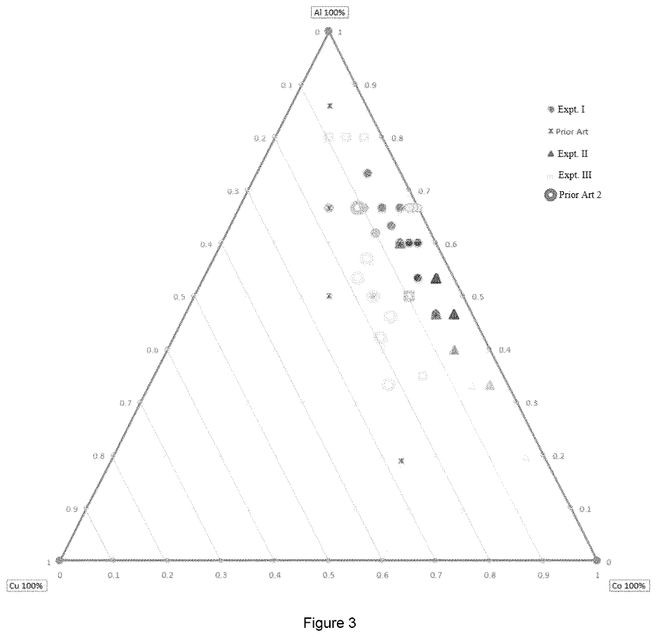

A graphical representation of the data from Table 3 is shown in FIG. 3. FIG. 3 shows NO_{X} conversion as a function of catalyst composition, with each axis corresponding to an amount of aluminum, cobalt or copper from 0 to 100%. The darker symbols in FIG. 3 with square, solid triangle and solid circle symbols indicate higher NO_{X} conversion, corresponding to the compositions listed in Table 3 with the highest NO_{X} conversion, compared to the same shapes with lighter shading, corresponding to the compositions listed in Table 3 with the lower NO_{X} conversion. For comparison, the composition of prior art catalyst compositions is also shown in FIG. 3 (marked with an “x” and a “doughnut”, shade of symbol not indicative of relative catalyst performance), to demonstrate the different composition of the prior art catalysts. The mixed metal oxide catalysts as described herein have different ratios of aluminum to cobalt to copper, resulting in improved performance in terms of NO_{X} conversion, as compared to prior art compositions. The squares, solid circles and solid triangles in FIG. 3 correspond to compositions as disclosed herein with varying ratios of Al:Co:Cu (labeled as Expt. I, Expt. II and Expt. III in FIG. 3).

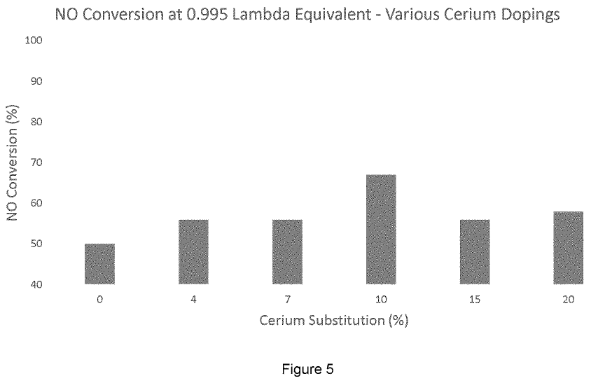

Using a compound of ratio 9:5:1 Al:Co:Cu, cerium was substituted on a molar percent basis for cobalt, and analyzed for NO_{X} at 0.995 lambda, as shown in, for example, FIG. 5 and Table 4.

TABLE 4
NOx conversion of mixed metal oxide catalysts
comprising cerium exposed at 0.998 lambda

Cerium Substitution (%)

| | 0 | 4 | 7 | 10 | 15 | 20 |
|---|---|---|---|---|---|---|
| NOₓ | 50 | 56 | 56 | 67 | 56 | 58 |
| conversion | | | | | | |

A graphical representation of the data from Table 4 is shown in FIG. 5. As can be seen from FIG. 5, the compositions as disclosed herein were effective at removing NOx from a gas at 0.995 lamda. Thus, doping may further improve NO_{X} conversion of the mixed metal oxide compositions or catalysts as disclosed herein.

In the present disclosure, all terms referred to in singular form are meant to encompass plural forms of the same. Likewise, all terms referred to in plural form are meant to encompass singular forms of the same. In addition, the use of “or” means “and/or” unless otherwise stated. The term “plurality” as used herein means more than one, for example, two or more, three or more, four or more, and the like. Unless defined otherwise, all technical and scientific terms used herein have the same meaning as commonly understood by one of ordinary skill in the art to which this disclosure pertains.

It should be understood that the compositions, catalyst, methods, and processes are described in terms of “comprising,” “containing,” or “including” various components or steps, the compositions and methods can also “consist essentially of” or “consist of the various components and steps”. Moreover, the indefinite articles “a” or “an”, as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”, or equivalent, “from a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Although individual embodiments are discussed, the disclosure covers all combinations of all those embodiments. Furthermore, no limitations are intended to the details of construction or design herein shown, other than as described in the claims below. Also, the terms in the claims have their plain, ordinary meaning unless otherwise explicitly and clearly defined herein. It is therefore evident that the particular illustrative embodiments disclosed above may be altered or modified and all such variations are considered within the scope of the present disclosure.

Many variations of the embodiments set out herein will suggest themselves to those skilled in the art in light of the present disclosure. Such variations are within the full intended scope of the appended claims.

1. A mixed metal oxide catalyst comprising aluminum, cobalt and copper, wherein the elemental ratio of aluminum to cobalt to copper is X:Y:1, wherein X is in the range of about 7 to about 20, and Y is in the range of about 3 to about 15, wherein at least a portion of the catalyst comprises a ternary spinel structure.

2. The mixed metal oxide catalyst of claim 1, wherein X is in the range of about 7 to about 18, and Y is in the range of about 3 to about 13, wherein mixed metal oxide catalyst comprises an amount of aluminum greater than or equal to the amount of cobalt.

3. The mixed metal oxide catalyst of claim 1, wherein: Cu⁺² and Co⁺² ions share the A site in the spinel type structure; and Co⁺³ and Al⁺³ ions share the B site of the spinel type structure.

4. The mixed metal oxide catalyst of claim 1, wherein the X-ray diffraction pattern is absent peaks associated with gamma alumina.

5. The mixed metal oxide catalyst of claim 1, further comprising a dopant.

6. The mixed metal oxide catalyst of claim 5, wherein the dopant is substituted for an equal molar amount of cobalt.

7. The mixed metal oxide catalyst of claim 6, wherein the dopant is substituted at about 0.1% to about 20%.

8. The mixed metal oxide catalyst of claim 5, wherein the dopant comprises cerium or manganese.

9. The mixed metal oxide catalyst of claim 1, further comprising a carrier material or a substrate.

10. The mixed metal oxide catalyst of claim 9, wherein the carrier material is uniformly dispersed in the mixed metal oxide catalyst or the mixed metal oxide catalyst is uniformly dispersed on the carrier material.

11. The mixed metal oxide catalyst of claim 9, wherein the substrate is porous.

12. The mixed metal oxide catalyst of claim 9, wherein the substrate comprises cordierite, alumina, zirconia, magnesium oxide, metal honeycombs, or ceramic beads.

13. A method to remove one or more pollutants from a gas stream comprising exposing the gas stream to the mixed metal oxide catalyst of claim 1.

14. The method of claim 13, wherein the gas stream comprises an exhaust gas stream, flue gas, diesel exhaust, kerosene exhaust, or any combination thereof.

15. The method of claim 13, wherein the exposing the gas stream to the mixed metal oxide catalyst is at an operating temperature of between 300° C. and 700° C.

16. A process for preparing a mixed metal oxide catalyst comprising:
(a) preparing a dispersion comprising a metal solution, wherein the metal solution comprises a solvent, and aluminium, copper and cobalt in solution, wherein the total concentration of metal ions in the solution is between about 0.5 M and about 5 M;
(b) applying the dispersion to a substrate;
(c) removing the solvent from the substrate to form a catalyst precursor; and
(d) calcining the catalyst precursor to produce the mixed metal oxide catalyst, wherein the mixed metal oxide catalyst comprises an elemental ratio of aluminum to cobalt to copper is X:Y:1, wherein X is in the range of about 7 to about 20, and Y is in the range of about 3 to about 15.

17. The process of claim 16, wherein X is in the range of about 7 to about 18, and Y is in the range of about 3 to about 13, and the amount of aluminum is greater than or equal to the amount of cobalt.

18. The process of claim 16, wherein the aluminum, copper and cobalt in the metal solution are each independently an oxide, a salt, an organometallic complex, or any combination thereof.

19. The process of claim 16, further comprising adding a carrier material and the carrier material is added to the dispersion during step (a).

20. The process of claim 16, wherein a total loaded dispersion is between 10% and 150% by weight of the total weight of the mixed metal oxide catalyst.

21.-36. (canceled)
